(19) United States
(12) Patent Application Publication
(10) Pub. No.: US 2025/0247737 A1
(43) Pub. Date: Jul. 31, 2025

(54) PROXY QUALITY OF SERVICE SETUP FOR PEER-TO-PEER COMMUNICATION

(71) Applicant: Samsung Electronics Co., Ltd., Suwon-si (KR)

(72) Inventors: Rubayet Shafin, Frisco, TX (US); Boon Loong Ng, Plano, TX (US); Peshal Nayak, Plano, TX (US); Vishnu Vardhan Ratnam, Plano, TX (US); Yue Qi, Plano, TX (US)

(21) Appl. No.: 19/029,637

(22) Filed: Jan. 17, 2025

Related U.S. Application Data
(60) Provisional application No. 63/626,896, filed on Jan. 30, 2024.

(51) Int. Cl. H04W 28/02

(52) U.S. Cl. CPC H04W 28/0268

(57) ABSTRACT

A first station (STA) in a wireless network, comprising a memory and a processor coupled to the memory. The processor is configured to cause transmitting, to an access point (AP), a request frame that requests for setting up a quality of service (QoS) flow for a second STA's peer to peer (P2P) traffic. The request frame includes one or more QoS parameters associated with the QoS flow and a field indicating a type of request frame. The processor is further configured to cause receiving, from the AP, a response frame in response to the request frame.

### CROSS REFERENCE TO RELATED APPLICATION

This application claims benefit of U.S. Provisional Application No. 63/626,896, entitled “Proxy QoS Setup for P2P Communication,” filed on Jan. 30, 2024, in the United States Patent and Trademark Office, the entire contents of which are hereby incorporated by reference.

### TECHNICAL FIELD

This disclosure relates generally to a wireless communication system, and more particularly to, for example, but not limited to, proxy quality of service (QoS) for peer-to-peer (P2P) communication in wireless networks.

### BACKGROUND

Wireless local area network (WLAN) technology has evolved toward increasing data rates and continues its growth in various markets such as home, enterprise and hotspots over the years since the late 1990s. WLAN allows devices to access the internet in the 2.4 GHz, 5 GHz, 6 GHz or 60 GHz frequency bands. WLANs are based on the Institute of Electrical and Electronic Engineers (IEEE) 802.11 standards. IEEE 802.11 family of standards aims to increase speed and reliability and to extend the operating range of wireless networks.

WLAN devices are increasingly required to support a variety of delay-sensitive applications or real-time applications such as augmented reality (AR), robotics, artificial intelligence (AI), cloud computing, and unmanned vehicles. To implement extremely low latency and extremely high throughput required by such applications, multi-link operation (MLO) has been suggested for the WLAN. The WLAN is formed within a limited area such as a home, school, apartment, or office building by WLAN devices. Each WLAN device may have one or more stations (STAs) such as the access point (AP) STA and the non-access-point (non-AP) STA.

The MLO may enable a non-AP multi-link device (MLD) to set up multiple links with an AP MLD. Each of multiple links may enable channel access and frame exchanges between the non-AP MLD and the AP MLD independently, which may reduce latency and increase throughput.

The description set forth in the background section should not be assumed to be prior art merely because it is set forth in the background section. The background section may describe aspects or embodiments of the present disclosure.

### SUMMARY

This disclosure may be directed to improvements to a wireless communications system, more particularly to provide a mechanism and protocol for proxy quality of service (QoS) setup for a station's (STA's) peer to peer (P2P) traffic.

An aspect of the disclosure provides a first station (STA) in a wireless network. The first STA comprises a memory and a processor. The processor is coupled to the memory. The processor is configured to cause transmitting, to an access point (AP), a request frame that requests a setup of a quality of service (QoS) flow for a second STA's peer to peer (P2P) traffic, the request frame including i) one or more QoS parameters associated with the QoS flow and ii) a field indicating a type of request frame. The processor is further configured to cause receiving, from the AP, a response frame in response to the request frame.

In an embodiment, the field indicates that the request frame is for setting up new QoS flow for the second STA's P2P traffic.

In an embodiment, the field indicates that the request frame is for removing a QoS flow for the second STA's P2P traffic.

In an embodiment, the field indicates that the request frame is for changing or modifying an existing QoS flow for the second STA's P2P traffic.

In an embodiment, the request frame includes a peer STA information field, the peer STA information field including information associated with the second STA.

In an embodiment, the response frame includes one or more QoS parameters that are associated with the second STA's P2P traffic.

In an embodiment, the request frame requests the AP to allocate a channel resource to the second STA.

An aspect of the disclosure provides an access point (AP) in a wireless network. The AP comprises a memory and a processor. The processor is coupled to the memory. The processor is configured to cause receiving, from a first station (STA), a request frame that requests a setup of a quality of service (QoS) flow for a second STA's peer to peer (P2P) traffic, the request frame including i) one or more QoS parameters associated with the QoS flow and ii) a field indicating a type of the request frame. The processor is further configured to cause transmitting, to the first STA, a response frame in response to the request frame. The processor is further configured to cause transmitting, to the second STA, a trigger frame to solicit a frame from the second STA based on the schedule indicated by the one or more QoS parameters.

In an embodiment, the trigger frame allocates a transmission opportunity (TXOP) to the second STA.

In an embodiment, the field indicates that the request frame is for setting up new QoS flow for the second STA's P2P traffic.

In an embodiment, the field indicates that the request frame is for removing a QoS flow for the second STA's P2P traffic.

In an embodiment, the field indicates that the request frame is for changing or modifying an existing QoS flow for the second STA's P2P traffic.

In an embodiment, the request frame includes a peer STA information field, the peer STA information field including information associated with the second STA.

In an embodiment, the response frame includes one or more QoS parameters that are associated with the second STA's P2P traffic.

In an embodiment, the request frame requests the AP to allocate a channel resource to the second STA.

An aspect of the disclosure provides a method performed by a first station (STA). The method comprises transmitting, to an access point (AP), a request frame that requests a setup of a quality of service (QoS) flow for a second STA's peer to peer (P2P) traffic, the request frame including i) one or more QoS parameters associated with the QoS flow and ii) a field indicating a type of request frame. The method further comprises receiving, from the AP, a response frame in response to the request frame.

In an embodiment, the field indicates that the request frame is for setting up new QoS flow for the second STA's P2P traffic.

In an embodiment, the field indicates that the request frame is for removing a QoS flow for the second STA's P2P traffic.

In an embodiment, the field indicates that the request frame is for changing or modifying an existing QoS flow for the second STA's P2P traffic.

In an embodiment, the request frame includes a peer STA information field, the peer STA information field including information associated with the second STA.

### BRIEF DESCRIPTION OF THE DRAWINGS

FIG. 1 shows an example of a wireless network in accordance with an embodiment.

FIG. 2A shows an example of AP in accordance with an embodiment.

FIG. 2B shows an example of STA in accordance with an embodiment.

FIG. 3 shows an example of multi-link communication operation in accordance with an embodiment.

FIG. 4 shows an example network in accordance with an embodiment.

FIG. 5 shows an example scenario of a resource request transmitted to AP by a STA for another STA's P2P transmission in accordance with an embodiment.

FIG. 6 shows an example action field of SCS Request frame in accordance with an embodiment.

FIG. 7 shows another example action field of SCS Request frame in accordance with an embodiment.

FIG. 8 shows an example Peer STA info element in accordance with an embodiment.

FIG. 9 shows an example scenario of SCS frame exchanges between a STA and an AP for another STA's uplink QoS in accordance with an embodiment.

FIG. 10 shows an example scenario of SCS frame exchanges between a STA and an AP for another STA's P2P traffic over a direct link with yet another STA in accordance with an embodiment.

FIG. 11 shows an example scenario of SCS frame exchanges between a STA and an AP for another STA's P2P traffic over a direct link with the STA in accordance with an embodiment.

FIG. 12 shows an example process for establishing a QoS flow for another STA in accordance with an embodiment.

FIG. 13 shows an example process for establishing QoS flow for another STA in accordance with an embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The present disclosure relates to a wireless communication system, and more particularly, to a Wireless Local Area Network (WLAN) technology. WLAN allows devices to access the internet in the 2.4 GHz, 5 GHz, 6 GHz or 60 GHz frequency bands. WLANs are based on the Institute of Electrical and Electronic Engineers (IEEE) 802.11 standards. IEEE 802.11 family of standards aim to increase speed and reliability and to extend the operating range of wireless networks.

The demand of wireless data traffic is rapidly increasing due to the growing popularity among consumers and businesses of smart phones and other mobile data devices, such as tablets, “note pad” computers, net books, eBook readers, and machine type of devices. In order to address the issue of increasing bandwidth requirements that are demanded for wireless communications systems, different schemes are being developed to allow multiple user terminals to communicate with a single access point by sharing the channel resources while achieving high data throughputs. Multiple Input Multiple Output (MIMO) technology represents one such approach that has emerged as a popular technique. MIMO has been adopted in several wireless communications standards such 802.11ac, 802.11ax etc.

Before undertaking the detailed description below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

Figures discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably-arranged system or device.

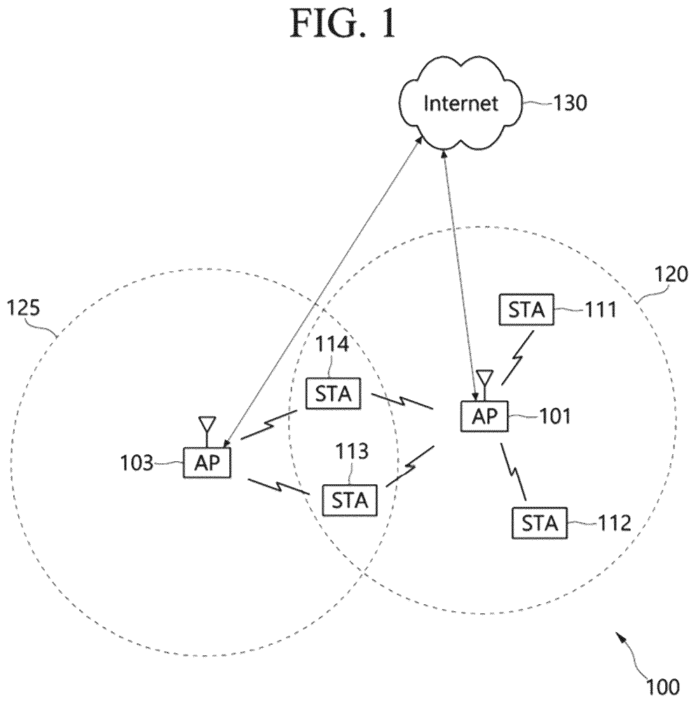

FIG. 1 shows an example wireless network 100 according to this disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes access points (APs) 101 and 103. The APs 101 and 103 communicate with at least one network 130, such as the Internet, a proprietary Internet Protocol (IP) network, or other data network. The AP 101 provides wireless access to the network 130 for a plurality of stations (STAs) 111-114 within a coverage area 120 of the AP 101. The APs 101-103 may communicate with each other and with the STAs 111-114 using WiFi or other WLAN communication techniques.

Depending on the network type, other well-known terms may be used instead of “access point” or “AP,” such as “router” or “gateway.” For the sake of convenience, the term “AP” is used in this patent document to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this patent document to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

In FIG. 1, dotted lines show the approximate extents of the coverage areas 120 and 125, which are shown as approximately circular for the purposes of illustration and explanation only. It should be clearly understood that the coverage areas associated with APs, such as the coverage areas 120 and 125, may have other shapes, including irregular shapes, depending upon the configuration of the APs and variations in the radio environment associated with natural and man-made obstructions.

As described in more detail below, one or more of the APs may include circuitry and/or programming for management of MU-MIMO and OFDMA channel sounding in WLANs. Although FIG. 1 shows one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101-103 could communicate directly with the network 130 and provide STAs with direct wireless broadband access to the network 130. Further, the APs 101 and/or 103 could provide access to other or additional external networks, such as external telephone networks or other types of data networks.

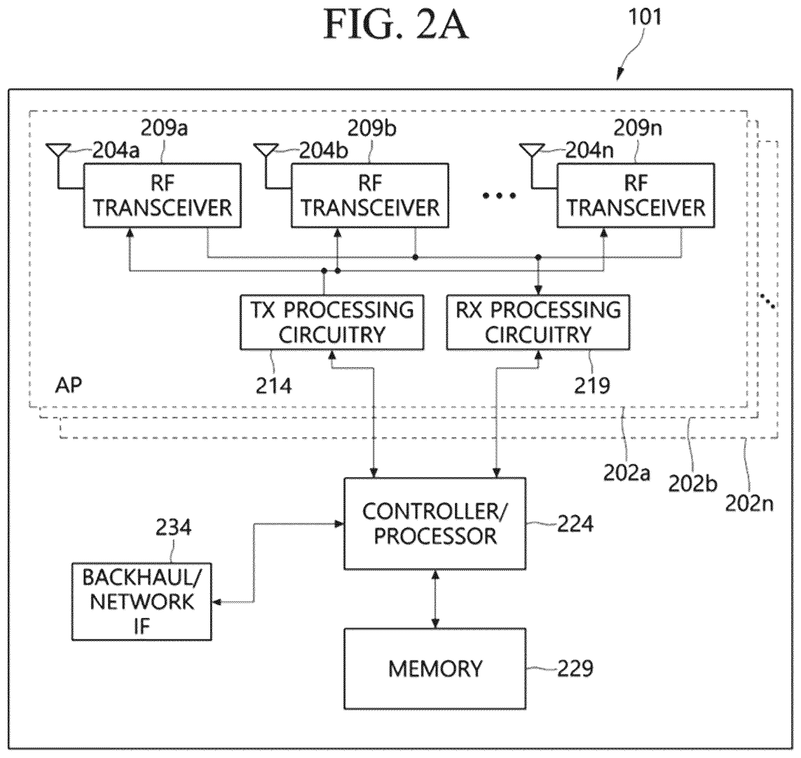

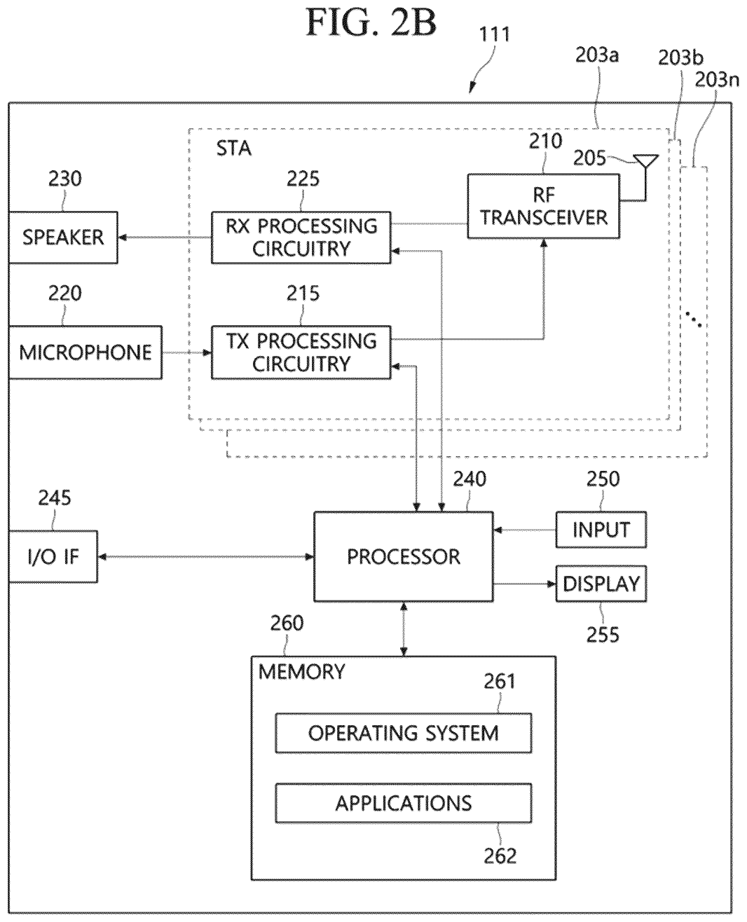

FIG. 2A shows an example AP 101 according to this disclosure. The embodiment of the AP 101 illustrated in FIG. 2A is for illustration only, and the AP 103 of FIG. 1 could have the same or similar configuration. However, APs come in a wide variety of configurations, and FIG. 2A does not limit the scope of this disclosure to any particular implementation of an AP.

As shown in FIG. 2A, the AP 101 includes multiple antennas 204a-204n, multiple RF transceivers 209a-209n, transmit (TX) processing circuitry 214, and receive (RX) processing circuitry 219. The AP 101 also includes a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate IF or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

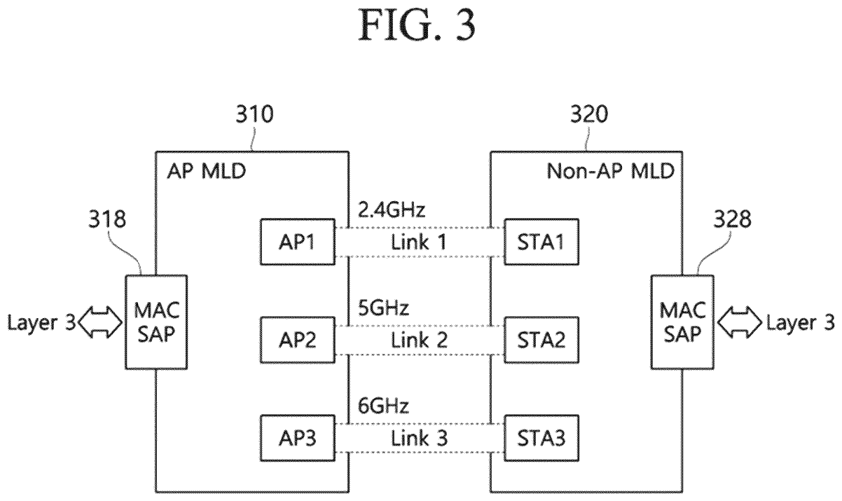

FIGS. 2 and 3 illustrate example electronic devices in accordance with an embodiment of this disclosure. In particular, FIG. 2 shows an example server 200, and the server 200 could represent the server 104 in FIG. 1. The server 200 can represent one or more encoders, decoders, local servers, remote servers, clustered computers, and components that act as a single pool of seamless resources, a cloud-based server, and the like. The server 200 can be accessed by one or more of the client devices 106-116 of FIG. 1 or another server.

The controller/processor 224 can include one or more processors or other processing devices that control the overall operation of the AP 101. For example, the controller/processor 224 could control the reception of forward channel signals and the transmission of reverse channel signals by the RF transceivers 209a-209n, the RX processing circuitry 219, and the TX processing circuitry 214 in accordance with well-known principles. The controller/processor 224 could support additional functions as well, such as more advanced wireless communication functions.

For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including a combination of DL MU-MIMO and OFDMA in the same transmit opportunity. In some embodiments, the controller/processor 224 includes at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for management of channel sounding procedures in WLANs. Although FIG. 2A shows one example of AP 101, various changes may be made to FIG. 2A. For example, the AP 101 could include any number of each component shown in FIG. 2A. As a particular example, an access point could include a number of interfaces 234, and the controller/processor 224 could support routing functions to route data between different network addresses. As another particular example, while shown as including a single instance of TX processing circuitry 214 and a single instance of RX processing circuitry 219, the AP 101 could include multiple instances of each (such as one per RF transceiver). Alternatively, only one antenna and RF transceiver path may be included, such as in legacy APs. Also, various components in FIG. 2A could be combined, further subdivided, or omitted and additional components could be added according to particular needs.

FIG. 2B shows an example STA 111 according to this disclosure. The embodiment of the STA 111 illustrated in FIG. 2B is for illustration only, and the STAs 111-115 of FIG. 1 could have the same or similar configuration. However, STAs come in a wide variety of configurations, and FIG. 2B does not limit the scope of this disclosure to any particular implementation of a STA.

As shown in FIG. 2B, the STA 111 includes antenna(s) 205, a radio frequency (RF) transceiver 210, TX processing circuitry 215, a microphone 220, and receive (RX) processing circuitry 225. The STA 111 also includes a speaker 230, a controller/processor 240, an input/output (I/O) interface (IF) 245, a touchscreen 250, a display 255, and a memory 260. The memory 260 includes an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an intermediate frequency (IF) or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the main controller/processor 240 controls the reception of forward channel signals and the transmission of reverse channel signals by the RF transceiver 210, the RX processing circuitry 225, and the TX processing circuitry 215 in accordance with well-known principles. The main controller/processor 240 can also include processing circuitry configured to provide management of channel sounding procedures in WLANs. In some embodiments, the controller/processor 240 includes at least one microprocessor or microcontroller.

The controller/processor 240 is also capable of executing other processes and programs resident in the memory 260, such as operations for management of channel sounding procedures in WLANs. The controller/processor 240 can move data into or out of the memory 260 as required by an executing process. In some embodiments, the controller/processor 240 is configured to execute a plurality of applications 262, such as applications for channel sounding, including feedback computation based on a received null data packet announcement (NDPA) and null data packet (NDP) and transmitting the beamforming feedback report in response to a trigger frame (TF). The controller/processor 240 can operate the plurality of applications 262 based on the OS program 261 or in response to a signal received from an AP. The main controller/processor 240 is also coupled to the I/O interface 245, which provides STA 111 with the ability to connect to other devices such as laptop computers and handheld computers. The I/O interface 245 is the communication path between these accessories and the main controller 240.

The controller/processor 240 is also coupled to the touchscreen 250 and the display 255. The operator of the STA 111 can use the touchscreen 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 2B shows one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B shows the STA 111 configured as a mobile telephone or smartphone, STAs could be configured to operate as other types of mobile or stationary devices.

As shown in FIG. 2B, in some embodiments, the STA 111 may be a non-AP MLD that includes multiple STAs 203a-203n. Each STA 203a-203n is affiliated with the non-AP MLD 111 and includes an antenna(s) 205, a RF transceiver 210, TX processing circuitry 215, and RX processing circuitry 225. Each STAs 203a-203n may independently communicate with the controller/processor 240 and other components of the non-AP MLD 111. FIG. 2B shows that each STA 203a-203n has a separate antenna, but each STA 203a-203n can share the antenna 205 without needing separate antennas. Each STA 203a-203n may represent a physical (PHY) layer and a lower media access control (MAC) layer.

FIG. 3 shows an example of multi-link communication operation in accordance with an embodiment. The multi-link communication operation may be usable in IEEE 802.11be standard and any future amendments to IEEE 802.11 standard. In FIG. 3, an AP MLD 310 may be the wireless communication device 101 and 103 in FIG. 1 and a non-AP MLD 220 may be one of the wireless communication devices 111-114 in FIG. 1.

As shown in FIG. 3, the AP MLD 310 may include a plurality of affiliated APs, for example, including AP 1, AP 2, and AP 3. Each affiliated AP may include a PHY interface to wireless medium (Link 1, Link 2, or Link 3). The AP MLD 310 may include a single MAC service access point (SAP) 318 through which the affiliated APs of the AP MLD 310 communicate with a higher layer (Layer 3 or network layer). Each affiliated AP of the AP MLD 310 may have a MAC address (lower MAC address) different from any other affiliated APs of the AP MLD 310. The AP MLD 310 may have a MLD MAC address (upper MAC address) and the affiliated APs share the single MAC SAP 318 to Layer 3. Thus, the affiliated APs share a single IP address, and Layer 3 recognizes the AP MLD 310 by assigning the single IP address.

The non-AP MLD 320 may include a plurality of affiliated STAs, for example, including STA 1, STA 2, and STA 3. Each affiliated STA may include a PHY interface to the wireless medium (Link 1, Link 2, or Link 3). The non-AP MLD 320 may include a single MAC SAP 328 through which the affiliated STAs of the non-AP MLD 320 communicate with a higher layer (Layer 3 or network layer). Each affiliated STA of the non-AP MLD 320 may have a MAC address (lower MAC address) different from any other affiliated STAs of the non-AP MLD 320. The non-AP MLD 320 may have a MLD MAC address (upper MAC address) and the affiliated STAs share the single MAC SAP 328 to Layer 3. Thus, the affiliated STAs share a single IP address, and Layer 3 recognizes the non-AP MLD 320 by assigning the single IP address.

The AP MLD 310 and the non-AP MLD 320 may set up multiple links between their affiliate APs and STAs. In this example, the AP 1 and the STA 1 may set up Link 1 which operates in 2.4 GHz band. Similarly, the AP 2 and the STA 2 may set up Link 2 which operates in 5 GHz band, and the AP 3 and the STA 3 may set up Link 3 which operates in 6 GHz band. Each link may enable channel access and frame exchange between the AP MLD 310 and the non-AP MLD 320 independently, which may increase date throughput and reduce latency. Upon associating with an AP MLD on a set of links (setup links), each non-AP device is assigned a unique association identifier (AID).

The following documents are hereby incorporated by reference in their entirety into the present disclosure as if fully set forth herein: i) IEEE 802.11-2020, “Wireless LAN Medium Access Control (MAC) and Physical Layer (PHY) Specifications,” ii) IEEE 802.11ax-2021, “Wireless LAN Medium Access Control (MAC) and Physical Layer (PHY) Specifications,” and iii) IEEE P802.11be/D3.0, “Wireless LAN Medium Access Control (MAC) and Physical Layer (PHY) Specifications.”

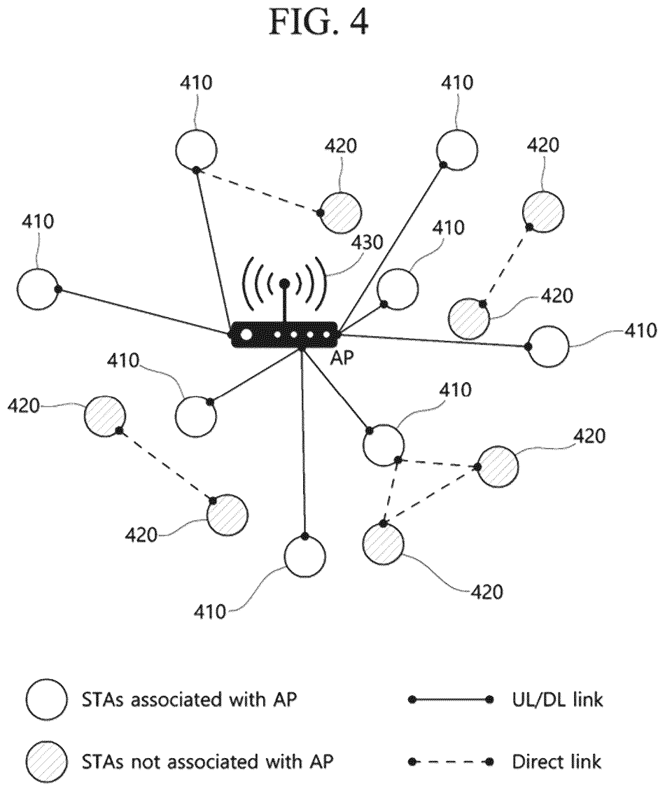

FIG. 4 shows an example network in accordance with an embodiment. The network depicted in FIG. 4 is for explanatory and illustration purposes. FIG. 4 does not limit the scope of this disclosure to any particular implementation.

In FIG. 4, a plurality of STAs 410 may be non-AP STAs associated with AP 430, and a plurality of STAs 420 may be non-AP STAs which are not associated with AP 430. Additionally, solid lines between STAs represent uplink or downlink with AP 430, while the dashed lines between STAs represent a direct link between STAs.

Next generation WLAN system needs to provide improved support for low-latency applications. Today, it is common to observe numerous devices operating on the same network as shown in FIG. 4. Many of these devices may have a tolerance for latency, but still compete with the devices running low-latency applications for the same time and frequency resources. In some cases, the AP 430 as a network controller may not have enough control over the unregulated or unmanaged traffic that contends with the low-latency traffic within the infrastructure basic service set (BSS). In some embodiments, the infrastructure BSS is a basic service set that includes an AP 430 and one or more non-AP STAs 410, while the independent BSS is a basic service set where non-AP STAs 420 communicate with each other without the need for a centralized AP. Some of the unregulated or unmanaged traffic that interferes with the latency-sensitive traffic in the BSS of the AP may originate from uplink, downlink, or direct link communications within the infrastructure BSS that the AP manages. Another source of the interference may be transmission from the neighboring infrastructure OBSS (Overlapping Basic Service Set), while others may come from neighboring independent BSS or P2P networks. Therefore, the next generation WLAN system needs mechanisms to more effectively handle unmanaged traffic while prioritizing low-latency traffic in the network.

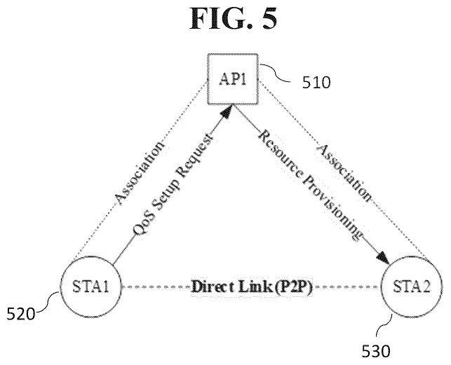

FIG. 5 shows an example scenario of a resource request transmitted to AP by a STA for another STA's P2P transmission in accordance with an embodiment. The scenario depicted in FIG. 5 is for explanatory and illustration purposes. FIG. 5 does not limit the scope of this disclosure to any particular implementation.

In FIG. 5, the example scenario includes an AP1 510, a STA1 520, and a STA2 530. The STA1 520 and the STA2 530 are associated with the AP1 510. Additionally, the STA1 520 and the STA2 530 have P2P direct link. In some embodiments, the STA1 520 and the STA2 530 have traffic between them, for example, latency-sensitive traffic for augmented reality (AR) or virtual reality (VR) applications. The STA1 520 transmits, to the AP1 510, a quality of service (QoS) setup request for the STA2 530. In response, the AP1 510 allocates or provides channel resources to STA2 530.

In an embodiment, a first STA may request that an AP allocate or provision channel resources for a second STA to facilitate the second STA's transmission over a direct link. The first STA may be associated with the AP. In some embodiments, the second STA may also be associated with the AP. In some embodiments, the second STA may also be associated with a different AP or may not be associated with any AP. In some embodiments, The first STA may have a direct link with the second STA. The first STA may not have a direct link with the second STA but the second STA may have a direct link with a third STA. The second STA may have multiple direct links established with different STAs. The second STA may have latency sensitive traffic that needs to be delivered over a P2P link.

In an embodiment, a first STA may transmit a stream classification service (SCS) Request frame to an AP for QoS provisioning for a second STA.

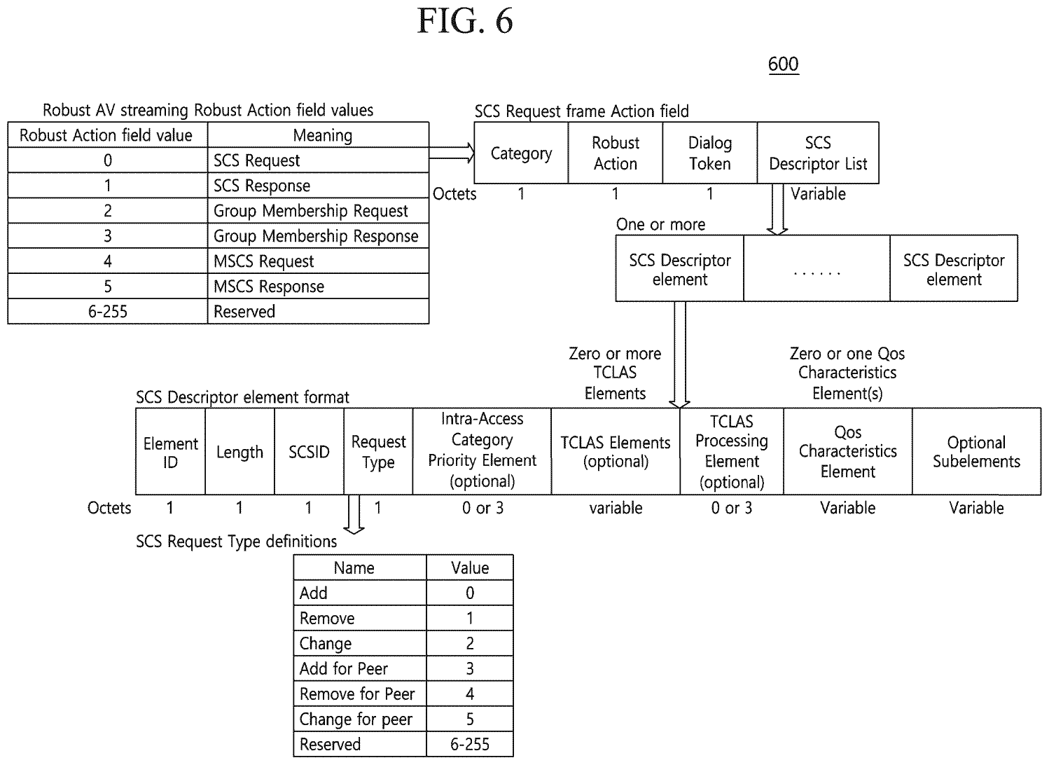

FIG. 6 shows an example action field of SCS Request frame 600 in accordance with an embodiment. The format depicted in FIG. 6 is for explanatory and illustration purposes. FIG. 6 does not limit the scope of this disclosure to any particular implementation.

Referring to FIG. 6, the action field of SCS Request frame 600 includes a Category field, a Robust Action field, a Dialog Token field, and an SCS Descriptor List field.

The Category field provides a category of the SCS Request frame 600. In an embodiment, the Category field may indicate a Robust AV streaming. The Robust Action field may indicate that the frame 600 is associated with a SCS request, as shown in FIG. 6. The Dialog Token field may be used for matching action responses with action requests where there are multiple, concurrent action requests. The SCS Descriptor List field may include one or more SCS Descriptor elements.

The SCS Descriptor element include an Element ID field, a Length field, a SCSID field, a Request Type field, and Intra-Access Category Priority Element field, a TCLAS Elements field, a TCLAS Processing Element field, a QoS Characteristic Element field, and an Optional Subelements field.

The Element ID field includes information identifying the SCS Descriptor element. The Length field indicates the number of octets in the SCS Descriptor element excluding the Element ID and Length fields of the SCS Descriptor element. The SCSID field is set to a nonzero value chosen by the STA identifying the SCS stream specified in this SCS Descriptor element. The Request Type field is set to a number to identify the type of SCS Request. In an embodiment, the Request Type field includes a syntax element indicating the type of request, including “Add” or “Add for Peer” as shown in FIG. 6. The Intra-Access Category Priority Element field is present when the Request Type field indicates a predetermined type, such as “Add” or “Change.” The traffic classification (TCLAS) Elements field includes zero or more TCLAS elements to specify how incoming medium access control (MAC) service data units (MSDUs) are classified as part of the SCS stream. The TCLAS Processing Element field is present when more than one TCLAS elements are present, and indicates how the multiple TCLAS elements are to be processed. The QoS Characteristics Element field includes zero or one QoS Characteristics elements to describe the traffic characteristics and QoS expectations of traffic flows that belong to the SCS stream. The Optional Subelements field may be reserved or used for vendor specific purposes.

In an embodiment, a first STA may transmit an SCS Request frame to an AP for QoS provisioning for a second STA. The first STA may set, in the SCS Request frame, the Request Type field of the SCS Descriptor element to a value, such as 0, that indicates “ADD” in order to set up a new QoS flow for the second STA as shown in FIG. 6. In an embodiment, the first STA may set, in the SCS Request frame, a new Request Type field value to a value that indicates “Add For Peer” in order to set up a new QoS flow for the second STA as shown in FIG. 6.

In an embodiment, a first STA may transmit an SCS Request frame to an associated AP and may indicate in the Request Type field of a first Descriptor element in the SCS Request frame the value for “Add for Peer.” The first STA may indicate that the QoS parameters indicated in the SCS Descriptor element corresponds to an SCS request for setting up a new QoS flow for a second STA.

In an embodiment, a first STA may transmit an SCS Request frame to an associated AP and may indicate in the Request Type field of a first SCS Descriptor element in the SCS Request frame the value for “Remove for Peer.” The first STA may indicate that the SCS Request frame is for removing a QoS flow for a second STA, where the QoS flow can be identified by the SCSID field of the SCS Descriptor element in the SCS Request frame.

In an embodiment, a first STA may transmit an SCS Request frame to an associated AP and may indicate in the Request Type field of a first SCS Descriptor element in the SCS Request frame the value for “Change for Peer.” The first may indicate that the SCS Request frame is for changing or modifying an existing QoS flow for a second STA, where the QoS Parameters in the SCS Descriptor element highlight the proposed changes for the revised QoS flow. The existing QoS flow may be identified by the SCSID field of the SCS Descriptor element in the SCS Request frame.

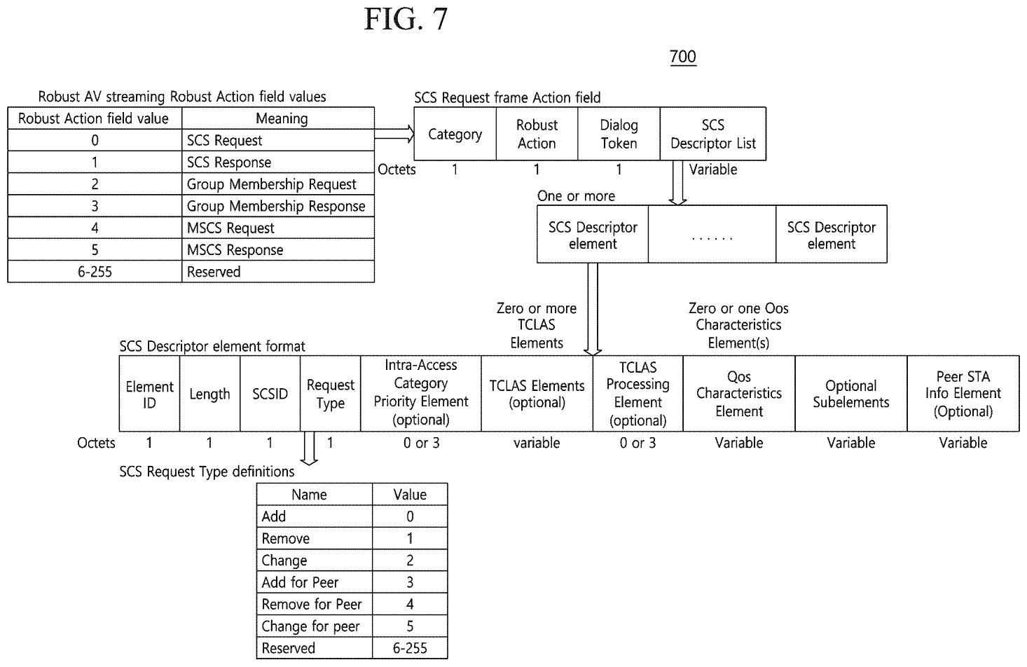

FIG. 7 shows another example action field of SCS Request frame 700 in accordance with an embodiment. The format depicted in FIG. 7 is for explanatory and illustration purposes. FIG. 7 does not limit the scope of this disclosure to any particular implementation.

Referring to FIG. 7, the action field of the SCS Request frame 700 is substantially similar to or the same as the example in FIG. 6, except that the SCS Descriptor element additionally includes a Peer STA Info Element field. The Peer STA Info Element field provides information regarding the Peer STA for which the request is being made.

In an embodiment, the SCS Descriptor element may include a Peer STA Info subfield in the SCS Descriptor element if the Request Type field of the SCS Descriptor element is set to either “Add for Peer,” “Remove for Peer,” or “Change for Peer.”

In an embodiment, the Peer STA Info Element subfield in the SCS Descriptor Element field may include one or more Peer STA Info Elements. The Peer STA Info Element may include information related to the STA for which the SCS request is transmitted. The Peer STA Info Element may include an identification of the STA for which the SCS request is made, such as an association ID (AID) or an MAC address of the STA. The Peer STA Info Element may include a basic service set (BSS) color for the AP with whom the STA is associated. The Peer STA Info Element may include an MAC address of the AP with whom the STA is associated. The Peer STA Info Element may include the link on which the STA is operating and channel resources are solicited. The Peer STA Info Element may include a number of peer devices with whom the STA has direct link setup. The Peer STA Info Element may include some priority information of the STA, such as priority information that may indicate whether the STA is a high-priority STA or low-priority STA. The priority information may also indicate whether the any of the peer STAs of the STA is high-priority STA. The Peer STA Info Element may include information about a STA whether or not the STA belongs to a P2P group. The Peer STA Info Element may include some identification of the multi-AP group where the STA belongs, such as a Multi-AP ID.

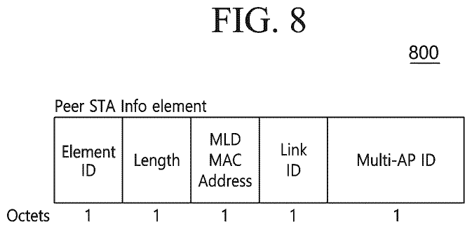

FIG. 8 shows an example Peer STA info element 800 in accordance with an embodiment. The format depicted in FIG. 8 is for explanatory and illustration purposes. FIG. 8 does not limit the scope of this disclosure to any particular implementation.

Referring to FIG. 8, the Peer STA Info Element 800 may include an Element ID field, a Length field, a MLD MAC Address field, a Link ID field and a Multi-AP ID field.

The Element ID field may include information identifying the Peer STA Info element. The Length field may indicate the length of the Peer STA info element. The MLD MAC Address field may indicate the medium access control (MAC) address for a multi-link device (MLD) in a multi-link operation. The Link ID may indicate the link in a multi-link operation context over which the resource AP is requested for P2P transmission. The Multi-AP ID field may include some identification of a multi-AP group to which the Peer STA belongs.

In an embodiment, an AP may receive an SCS Request frame from an associated first STA where the SCS Request frame is for setting up an SCS stream or QoS flow for a second STA. In response, the AP can respond to the first STA by sending an SCS Response frame. The SCS Response frame may contain an SCS Descriptor element that indicates that the QoS parameters indicated in the SCS Descriptor element correspond to the second STA. The format of the SCS Descriptor element in the SCS Response frame may be similar or the same as the format described in FIGS. 6 and 7.

In an embodiment, an AP may respond to a first STA by transmitting an SCS Response frame to the first STA when the first STA transmits, to the AP, an SCS Request frame for QoS setup for a second STA and the AP accepts the request. Subsequently, when the SCS request is for setting up an uplink QoS flow or downlink QoS flow for the second STA and the AP accepts the request, the AP may deliver, to the second STA, a trigger frame, such as a basic trigger frame to solicit uplink frame or to deliver downlink frames based on the schedule indicated in the QoS Characteristics element included in the SCS Request frame.

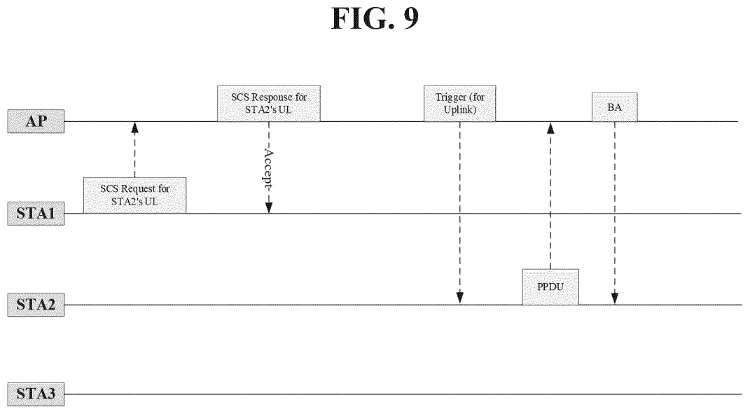

FIG. 9 shows an example scenario of SCS frame exchanges between a STA and an AP for another STA's uplink QoS in accordance with an embodiment. The scenario depicted in FIG. 8 is for explanatory and illustration purposes. FIG. 8 does not limit the scope of this disclosure to any particular implementation.

Referring to FIG. 9, STA1 transmits, to the AP, an SCS Request frame for setting up an uplink (UL) QoS flow on behalf of STA2. In response, the AP transmits, to STA1, an SCS Response frame indicating that the AP accepts the request in the SCS Request frame. Subsequently, the AP transmits, to STA2, a trigger frame to solicit uplink frame from STA2 based on the schedule indicated in the QoS Characteristic element in the SCS Request frame. In response, STA2 transmits, to the AP, a physical layer (PHY) protocol data unit (PPDU). In response, the AP transmits, to STA2, a block acknowledgement (BA).

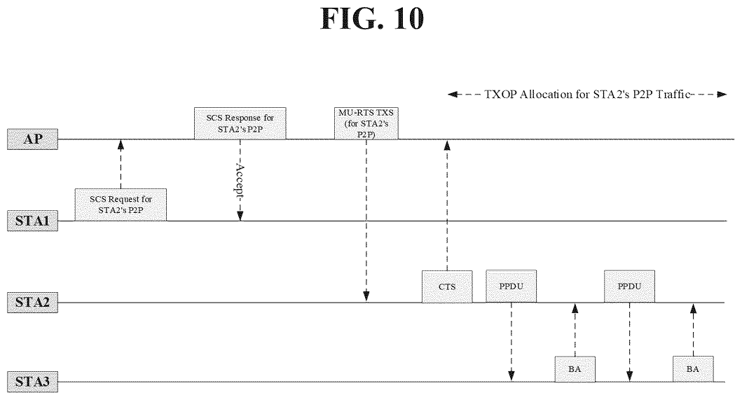

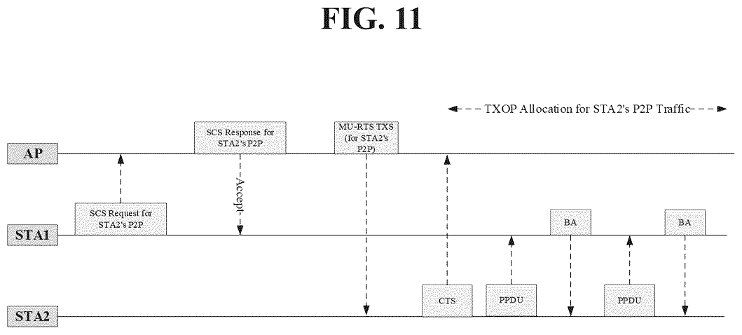

In an embodiment, an AP may respond to a first STA by transmitting an SCS Response frame to the first STA if the first STA transmits, to the AP, an SCS Request frame for QoS setup for a second STA and the AP accepts the request. The AP may deliver a trigger frame, such as a multi-user request to send (MU-RTS) triggered transmission opportunity (TXOP) sharing (TXS) Trigger frame, to the second STA based on the schedule indicated in the QoS Characteristics element included in the SCS Request frame. The MU-RTS TXOP TXS trigger frame may allocate TXOP to the second STA, enabling the second STA to deliver its P2P traffic to the first STA and a third STA over a direct link if the SCS request is for setting up a P2P QoS flow for the second STA and the AP accepts the request as shown in FIG. 10 and FIG. 11.

FIG. 10 shows an example scenario of SCS frame exchanges between a STA and an AP for another STA's P2P traffic over a direct link with yet another STA in accordance with an embodiment. The scenario depicted in FIG. 10 is for explanatory and illustration purposes. FIG. 10 does not limit the scope of this disclosure to any particular implementation.

Referring to FIG. 10, STA1 transmits, to the AP, an SCS Request frame requesting a setup of a P2P QoS flow for STA2. In response, the AP transmits, to STA1, an SCS Response frame accepting the request in the SCS Request frame. Subsequently, the AP transmits, to STA2, a MU-RTS TXS trigger frame allocating a TXOP to STA2 for delivering P2P traffic. In response, STA2 transmits, to the AP, a clear-to-send (CTS). Subsequently, STA2 transmits, to STA3, a PPDU using the allocated TXOP. STA3 transmits, to STA2, a BA in response. STA2 performs P2P communication with STA3 for the duration of the allocated TXOP.

FIG. 11 shows an example scenario of SCS frame exchanges between a STA and an AP for another STA's P2P traffic over a direct link with the STA in accordance with an embodiment. The scenario depicted in FIG. 11 is for explanatory and illustration purposes. FIG. 11 does not limit the scope of this disclosure to any particular implementation.

Referring to FIG. 11, STA1 transmits, to the AP, an SCS Request frame requesting a setup of P2P QoS flow for STA2. In response, the AP transmits, to STA1, an SCS Response frame accepting the request in the SCS Request frame. Subsequently, the AP transmits, to STA2, a MU-RTS TXS trigger frame allocating a TXOP to STA2 for delivering P2P traffic. In response, STA2 transmits, to the AP, a CTS. Subsequently, STA2 transmits, to STA1, a PPDU using the allocated TXOP. STA1 transmits, to STA2, a BA in response. STA2 performs P2P communication with STA1 for the duration of the allocated TXOP.

In an embodiment, a STA may indicate a request for uplink, downlink or P2P (direct link) in the Direction subfield of the QoS Characteristics element of an SCS Request frame. An AP may indicate the request for uplink, downlink or P2P (direct link) in the Direction subfield of the QoS Characteristics element of the SCS Response frame.

In an embodiment, a STA may transmit a frame other than an SCS Request frame for requesting QoS flow for another STA. The STA may include information similar to the information included in the SCS Request frame.

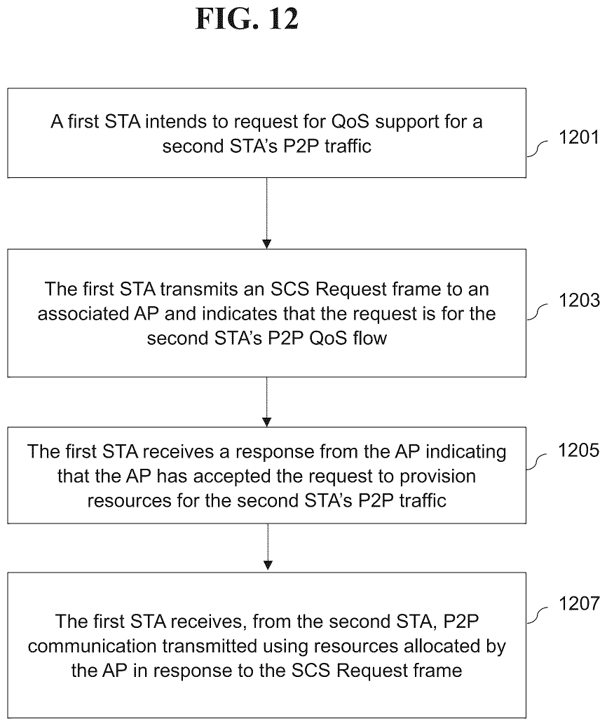

FIG. 12 shows an example process 1200 for establishing a QoS flow for another STA in accordance with an embodiment. The process depicted in FIG. 12 is for explanatory and illustration purposes and performed by a STA. FIG. 12 does not limit the scope of this disclosure to any particular implementation.

Referring to FIG. 12, the process 1200 begins at operation 1201. In operation 1201, a first STA intends to request for QoS support for a second STA's P2P traffic.

In operation 1203, the first STA transmits, to an associated AP, an SCS Request indicating that the request is to establish a P2P QoS flow for the second STA.

In operation 1205, The first STA receives a SCS response frame from the AP indicating that the AP has accepted the request to establish the P2P QoS flow for the second STA. In an embodiment, the AP provisions channel resources to the second STA for the P2P communication.

In operation 1207, the first STA receives, from the second STA, P2P traffic via a direct link between the first STA and the second STA using channel resources allocated by the AP in the response to the SCS Request frame. The resources may be allocated in the form of TXOP allocation to enable the second STA's P2P transmission.

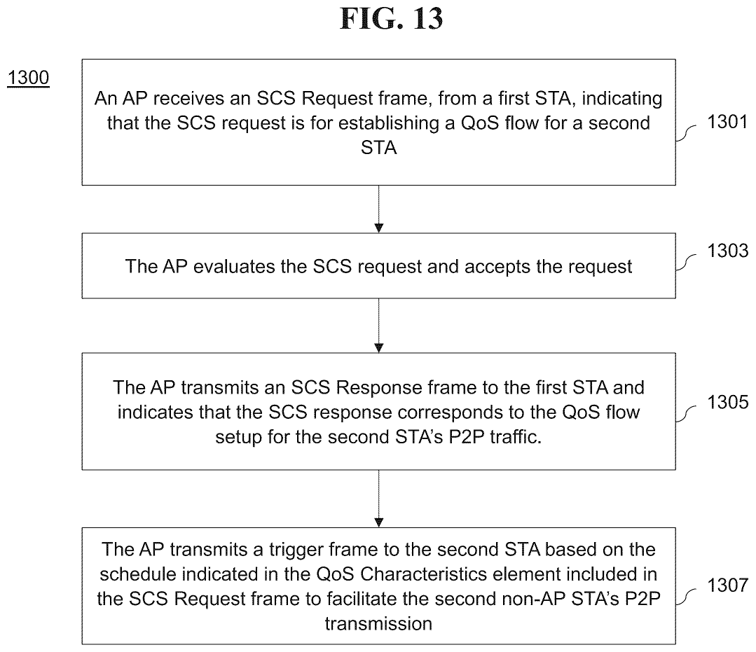

FIG. 13 shows an example process 1300 for establishing QoS flow for another STA in accordance with an embodiment. The process 1300 depicted in FIG. 13 is for explanatory and illustration purposes and is performed by an AP. FIG. 13 does not limit the scope of this disclosure to any particular implementation.

Referring to FIG. 13, the process 1300 begins at operation 1301. In operation 1301, an AP receives, from a first STA, an SCS Request frame indicating that the SCS request is for establishing a QoS flow for a second STA.

In operation 1303, the AP evaluates the SCS request indicated in the SCS Request frame and accepts the request.

In operation 1305, the AP transmits, to the first STA, an SCS Response frame to the first STA, indicating that the SCS response corresponds to the QoS flow setup for the second non-AP STA's P2P traffic. The SCS response frame may also indicate the acceptance of the SCS request.

In operation 1307, the AP transmits, to the second STA, a trigger frame based on the schedule indicated in the QoS Characteristics element included in the SCS Request frame. The trigger frame facilitates the second STA's P2P transmission.

The disclosure provides mechanisms and protocols for proxy QoS setup for a STA's P2P traffic, including an indication of the type of request in the request frame, such as adding, removing or changing a QoS flow, as well as adding, removing changing a QoS flow for Peer STA.

According to various embodiments, a first STA requests, from an AP, a resource on behalf of a second STA so that AP will be able to efficiently allocate time (or TXOP) of the pending traffic from the first STA to the second or from the second STA to the first STA in their P2P communication, so that latency sensitive traffic may be delivered in a timely manner.

The various illustrative blocks, units, modules, components, methods, operations, instructions, items, and algorithms may be implemented or performed with processing circuitry.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the subject technology. The term “exemplary” is used to mean serving as an example or illustration. To the extent that the term “include,” “have,” “carry,” “contain,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, the description may provide illustrative examples and the various features may be grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The embodiments are provided solely as examples for understanding the invention. They are not intended and are not to be construed as limiting the scope of this invention in any manner. Although certain embodiments and examples have been provided, it will be apparent to those skilled in the art based on the disclosures herein that changes in the embodiments and examples shown may be made without departing from the scope of this invention.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A first station (STA) in a wireless network, comprising:
a memory; and
a processor coupled to the memory, the processor configured to cause:
transmitting, to an access point (AP), a request frame that requests a setup of a quality of service (QoS) flow for a second STA's peer to peer (P2P) traffic, the request frame including i) one or more QoS parameters associated with the QoS flow and ii) a field indicating a type of request frame; and
receiving, from the AP, a response frame in response to the request frame.

2. The first STA of claim 1, wherein the field indicates that the request frame is for setting up new QoS flow for the second STA's P2P traffic.

3. The first STA of claim 1, wherein the field indicates that the request frame is for removing a QoS flow for the second STA's P2P traffic.

4. The first STA of claim 1, wherein the field indicates that the request frame is for changing or modifying an existing QoS flow for the second STA's P2P traffic.

5. The first STA of claim 1, wherein the request frame includes a peer STA information field, the peer STA information field including information associated with the second STA.

6. The first STA of claim 1, wherein the response frame includes one or more QoS parameters that are associated with the second STA's P2P traffic.

7. The first STA of claim 1, wherein the request frame requests the AP to allocate a channel resource to the second STA.

8. An access point (AP) in a wireless network, comprising:
a memory; and
a processor coupled to the memory, the processor configured to cause:
receiving, from a first station (STA), a request frame that requests a setup of a quality of service (QoS) flow for a second STA's peer to peer (P2P) traffic, the request frame including i) one or more QoS parameters associated with the QoS flow and ii) a field indicating a type of the request frame;
transmitting, to the first STA, a response frame in response to the request frame; and
transmitting, to the second STA, a trigger frame to solicit a frame from the second STA based on the schedule indicated by the one or more QoS parameters.

9. The AP of claim 8, wherein the trigger frame allocates a transmission opportunity (TXOP) to the second STA.

10. The AP of claim 8, wherein the field indicates that the request frame is for setting up new QoS flow for the second STA's P2P traffic.

11. The AP of claim 8, wherein the field indicates that the request frame is for removing a QoS flow for the second STA's P2P traffic.

12. The AP of claim 8, wherein the field indicates that the request frame is for changing or modifying an existing QoS flow for the second STA's P2P traffic.

13. The AP of claim 8, wherein the request frame includes a peer STA information field, the peer STA information field including information associated with the second STA.

14. The AP of claim 8, wherein the response frame includes one or more QoS parameters that are associated with the second STA's P2P traffic.

15. The AP of claim 8, wherein the request frame requests the AP to allocate a channel resource to the second STA.

16. A method performed by a first station (STA), comprising:
transmitting, to an access point (AP), a request frame that requests a setup of a quality of service (QoS) flow for a second STA's peer to peer (P2P) traffic, the request frame including i) one or more QoS parameters associated with the QoS flow and ii) a field indicating a type of request frame; and
receiving, from the AP, a response frame in response to the request frame.

17. The method of claim 16, wherein the field indicates that the request frame is for setting up new QoS flow for the second STA's P2P traffic.

18. The method of claim 16, wherein the field indicates that the request frame is for removing a QoS flow for the second STA's P2P traffic.

19. The method of claim 16, wherein the field indicates that the request frame is for changing or modifying an existing QoS flow for the second STA's P2P traffic.

20. The method of claim 16, wherein the request frame includes a peer STA information field, the peer STA information field including information associated with the second STA.
